(19) United States
(12) Patent Application Publication
(10) Pub. No.: US 2006/0182168 A1
(43) Pub. Date: Aug. 17, 2006

(54) Training sequence detection scheme and device of downlink in tdd/cdma system

(76) Inventors: Dong Wang, Shanghai (CN); Luzhou Xu, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/541,005

(22) PCT Filed: Dec. 29, 2003
(86) PCT No.: PCT/IB03/06251

§ 371 Date: Jan. 26, 2006

(30) Foreign Application Priority Data
Dec. 30, 2002 (CN) 021604614

(51) Int. Cl. H04B 1/69

(52) U.S. Cl. 375/143

(57) ABSTRACT

This invention provides a detection method and device for the training sequence in a downlink TDD/CDMA system. In some TDD/CDMA systems, Multi-user detection (MUD) can be applied in UE, but the conventional training sequence detection method of great complexity. This invention is to perform matched filter operation on the training sequence of the desired users at at possible positions to get the adaptive threshold values detecting training sequence intensity and the multi-path positions, which correspond to the output peak values of the matched filter. Afterwards it performs the matched filter operation for other possible training sequences only at those peak positions mentioned above. This invention uses adaptive threshold value to detect the training sequence intensity, and the algorithm is improved greatly.

### FIELD OF TECHNOLOGY

This invention relates to Time Division Duplex/Code Division Multiple Access (TDD/CDMA) system, especially to a detection method and device for the down-link training sequence in a TDD/CDMA system.

### BACKGROUND OF THE INVENTION

In a TDD/CDMA communication system, multiple signals are sent using the same frequency, and distinguished with different channel codes and time slots. In such a system, data is transmitted by communication pulse. Usually a communication pulse string consists of a data code segment, a training sequence, and a protection interval. Every communication pulse has a private channel code and a midamble code. User equipment (UE) estimates the channel response between the transmitter and the receiver using the midamble. As an example, the FIG. 1 shows the time slot structure of TD-SCDMA.

In this system, multi-channel communication pulse strings of different subscribers can be sent out in the same time slot. This will lead to Multi Access Interference (MAI), even fail to receive the faded original subscriber signal. Multi-user Detection (MUD) algorithm has been advanced to solve this problem, which allows simultaneous recovery of all the communication pulses within one time slot. To recover all of the pulse data, the MUD receiver has to know all the channel codes as well as the channel response. But generally, An User Equipment (UE) only knows its own channel code and training sequence, therefore MUD can't be used in UE directly.

In some TDD/CDMA systems, for example, in the synchronized TD-SCDMA and the Wide Code Division Multi-address/Time Division Diplex (WCDMA/TDD) default training sequence allocation code method, every training sequence correlates with a set of channel codes. Therefore UE can detect the active training sequence; then we can get the active channel codes according to the relationship between the training sequence and the channel code. Thus MUD can be used in UE. The patent, American Application Number US 2001/00 24426 A1, titled “the Method Sustaining Multi-user Detection in the Downlink”, describes the simplified transmitting apparatus of a base station and an UE receiving device with MUD. Every generator generates one user communication data. In the succeeding frequency spreading and modulation module, the communication data mentioned above is frequency-spread by the corresponding channel code, and inserted with corresponding training sequence, then we obtain the communication pulse as shown in FIG. 1. The communication pulses from different users are merged in the succeeding combiner, and then are modulated upon the carrier signal before being sent out via antennas. In the user device receiver, the channel estimating device estimates channel pulse response and the amplitude of the training sequence. Based on the output of channel estimation, the training sequence detection device can judge which sequence is active. And then, the active channel code will be detected finally depending on the detected training sequence and the relationship between training sequence and the channel code. The MUD device recovers the communication pulse using the detected channel codes and the parameter evaluation of the estimated channel response.

It is remarkable that the amplitude evaluation of every communication pulse string can be used to judge whether the training sequence is active. In fact, the training sequence detection is a part of the channel estimation. Whether the training sequence is active can be judged by its amplitude evaluation. If the training sequence amplitude is small enough, it can be concluded that this training sequence does not exist (or does not be transmitted).

Generally speaking, there are two channel estimation methods to detect the training sequence: the time domain technique and the frequency domain technique. Followed is the introduction on time domain training sequence detection. A conventional method is the matched filter method, which is similar to the channel codes detection. FIG. 3 is the flow of this method.

In the matched filter method, over sampled signal is transferred to the training sequence matched filter group which performs matched filter operation on the training sequence of the original subscriber, and the output is transferred to the active training sequence probe unit which compares the output power peak value with the predefined threshold value to judge whether the training sequence is active. If the peak value exceeds the threshold value, the training sequence is regarded as active, and the active user flag is set to 1. In MUD, All the active channel codes can be obtained employing the detected active user flags mentioned above and the corresponding relation between the channel code and the training sequence. Then via the control switch K, the output of the matched filter is sent to the MRC unit which makes use of the fact that all the active training sequences are transmitted through the same wireless channel, so it can estimate the wireless channel parameter, such as multi-path parameter, with all the matched filter output of the active training sequence. Here the MRC rule is adopted, as disclosed in International Application Number WO 02/09375, titled “the evaluation approach of the downlink channel in the UMTS system”. The MRC can improve the precision of the channel estimation, especially in the case that the current training sequence intensity is weak while other active training sequence intensity is strong. If we only use the channel estimation of the current training sequence, the precision will decrease because of the poor SNR. But if we can merge the channel estimation of other active training sequences, which have a stronger energy and higher channel estimation precision, MRC will also has higher precision. Lastly, MRC transfers the estimated training sequence intensity and the channel response parameter to MUD to recover the user data.

The matched filter operation is very complex. And the complexity of other units depends on their special arithmetic.

But this method still has some problems. One is high complexity which leads to high power consumption, especially critical to UE. Another problem is that it is difficult to choose an optimal fixed threshold value, since it depends on the received signal power, the noise power and the channel fade characteristic. So it is rather difficult to assure its performance in all the possible SNR range.

### SUMMARY OF THE INVENTION

The purpose of this invention is to provide a new training sequence detection method based on conventional matched filter method, which sets a training sequence threshold value based on the noise power estimation. Note that all the active communication pulses are transmitted via the same channel and therefore the channel parameters are equal. Taking advantage of this property, the method to search the peak value of UE receiver-based matched filter is simplified. Therefore it keeps up the capability and the reasonable complexity to UE.

The other purpose is to offer a mobile terminal which detects the training sequence utilizing the new detection method mentioned above.

This invention is realized in the following way.

A method for detecting the downlink training sequence in a TDD/CDMA system, comprising the following steps:

a. Perform matched filter operation on the training sequence of this mobile terminal to get many peak positions;

b. Detect the intensity of training sequence for other mobile terminals according to the positions corresponding to multiple peak values;

c. Judge whether the training sequences for other mobile terminals are active by the detected training sequences intensity;

Wherein, an adaptive threshold value, which is predefined times of the estimated noise power, may be derived by the matched filter operation of step (a). The noise power may be obtained in this way: first to get the power of the peaks obtained by the matched filter operation of step (a) excluding the multiple peaks, then average these powers.

Wherein the amplitudes of the peaks in Step (a) are N times of the maximal peaks, where N ranges 0˜1 and can be optimized according to a given system. Usually N is approximately equal to 0.5. Moreover, multiple peak values are verified with the noise power to remove false peaks. It is in this way: if the amplitude of the peak value is bigger than the predefined times of the noise power, it is true; otherwise, it is false.

The judgment method in Step c is: compare the peak value obtained in Step b and the threshold value in Step c, if the peak value is bigger, the training sequence is active.

This invention needs no other special hardware but conventional matched filter. Compared with the conventional method, the complexity decreases greatly. Because it uses adaptive threshold value based on the noise power estimation, simulation shows it has a better performance than the conventional matched filter method.

### BRIEF DESCRIPTION OF THE DRAWINGS

FIG. 1 is the structure diagram of TD-SCDMA;

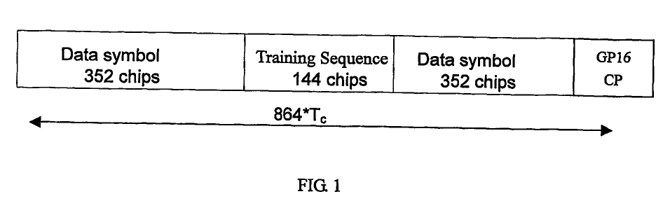

FIG. 2 illustrates the conventional matched filter method;

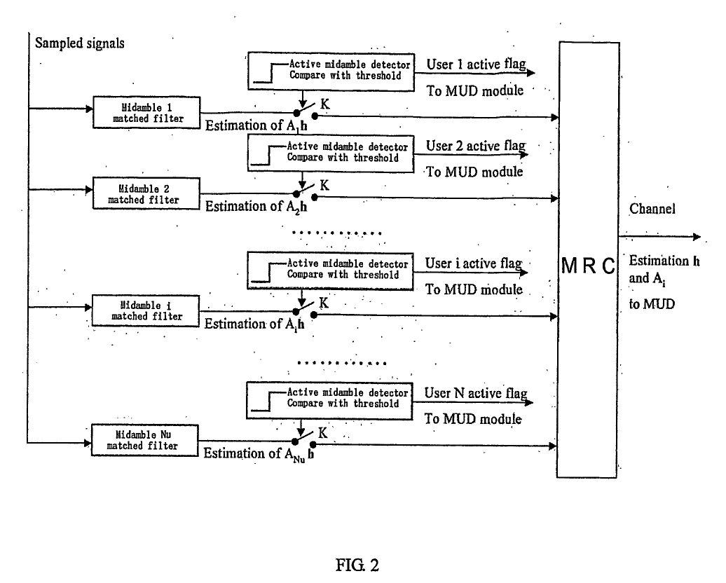

FIG. 3 is the method of getting the training sequence threshold value according to the matched filter output of the original subscriber;

FIG. 4 shows the cycling autocorrelation of the basic training sequence of a TD_SCDMA system;

FIG. 5 is a flow chart illustrating this training sequence detection method according to this invention;

FIG. 6 shows a UE receiver according to the training sequence detection method of this invention.

### DETAILED DESCRIPTION OF THE PREFERRED EMBODIMENTS

The detailed description of the invention is now described referring to the figures.

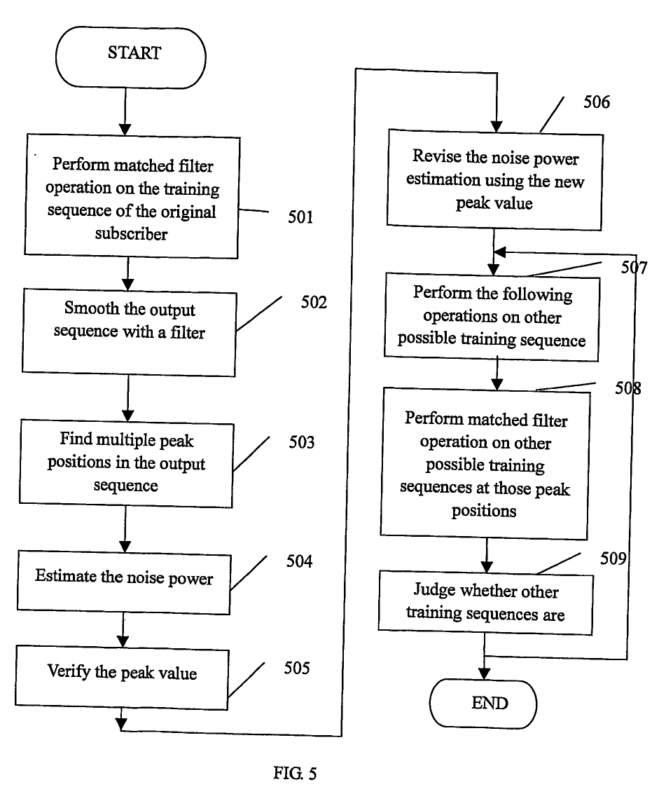

FIG. 5 illustrates the solution of a TD-SCDMA system.

First, perform matched filter operation on the training sequence of the original subscriber (Step 501). Next, smooth the matched filter output using a filter (such as FIR with 5 taps), (Step 502). Then, select not more than 4 peaks in the outputs of the FIR (Step 503). We only choose those peaks bigger than 0.5 times of the maximal peak amplitude so that every peak has a considerable amplitude. The time value is a parameter set according to the TD-SCDMA system of this embodiment and can be optimized according to the demand of the system.

Based on the matched filter output of training sequence of the original subscriber, the noise power can be estimated so as to set a threshold value for the training sequence intensity (step 504).

The reason to set a threshold value is that if a constant threshold value is applied, the performance cannot be assured since SNR is changing in a large range. If the threshold value is too high, some active training sequences cannot be detected, which is called “missing detection”. If the threshold value is too low, some inactive training sequences are taken for active because of the false peak owing to the noise, which is called “false alarm”. So it is difficult to assure the performance using a constant threshold value. To solve this problem this invention adopts an adaptive threshold value for the training sequence intensity to minimize the error rate of the “missing detection” and the “false alarm”.

This adaptive threshold value for the training sequence intensity, which is M times of the noise power estimation, is an adaptive threshold based on the noise estimation which assures that the false alarm probability is approximately a constant. M is a constant parameter.

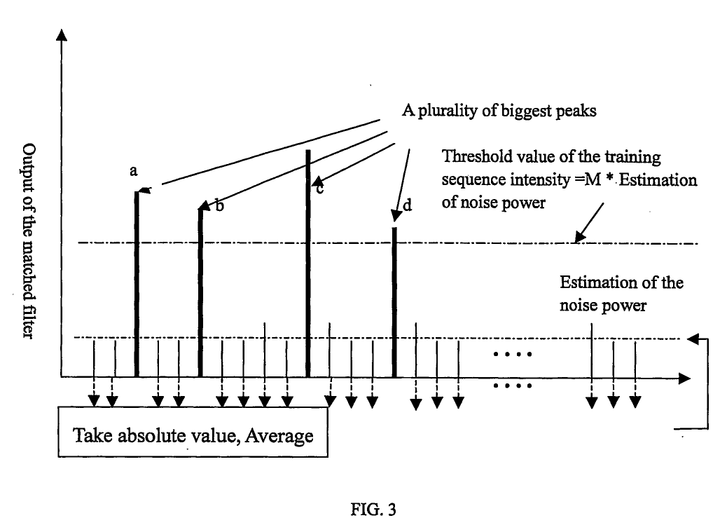

FIG. 3 illustrates the method to get the threshold value of the training sequence according to the matched filter output of the original subscriber. The noise power can be got by calculating the average power of the peaks excluding some maximums, which are the matched filter output of the training sequence for the current mobile terminal. The reason is,

The signal received by UE can be expressed as
r=x₁*hs₀+x₂*hs₁+ . . . +xₚ*hsₚ₋₁

Wherein xi is the training sequence of the user i, according to the training sequence characteristic specified by the WCDMA/TDD standard, xi is also the circular shift vector of x1.

n0 is an additional Gaussian white noise

hs₁=A₁*h₁ i=0,1, . . . w—1

hs₁=A₂*h_{i-w} i=w,w+1, . . . ,2w−1

hs₁=A₃*h_{i-2w} i=2w,2w+1, . . . ,3w−1 . . .

Where Ai is the training sequence signal intensity of the user i, hi (i=0,1, . . . w−1) is the response vector of the wireless channel.

Assume x1 is the training sequence of the original subscriber, thus the output of the matched filter is

MF₁(i)= [symbol] (0−i)*hs₀+ [symbol] (1−i)*h+ . . . +(P−1−i)*hsₚ+n₀

[symbol] (i),i=0 . . . w−1 is the cycling autocorrelation output of x1, and

[symbol] (i)= [symbol] (i+P)

[symbol] (i)=x₁^{H}*wᵢ₊₁

If hs₀ is high enough, there is a propagation path at this position, the output MF₁(i) of the matched filter includes two parts: [symbol] (0)*hs₀ and the noise background comprising MAI, multi-path interference and Gaussian white noise. [symbol] (0)*hs₀ will cause a peak of the matched filter output at the corresponding position.

If hs₀ is very low, there is no propagation path at this position, the output MF₁(i) of the matched filter is a noise background only comprising MAI, multi-path interference and Gaussian white noise.

If we omits MAI and multi-path interference, the output of matched filter at all the other positions except for the peak positions is only a Gaussian white noise. So the noise power estimation can be regarded as the variance estimation a of the Gaussian white noise. Because the propagation channels of each communication pulse are identical, the threshold value to detect the training sequence intensity can be used in all the active training sequence probe units as shown in FIG. 3.

Because the threshold value is Mσ, the probability of the spurious alarm is P(abs(n)>Mσ), where n is composite Gaussian white noise. abs(n) complies with Rayleigh distribution. When M is determined, the probability of false alarm is also determined and does not change with the SNR of the inputs. So we can determine the probability of false alarm depending on the choice of M.

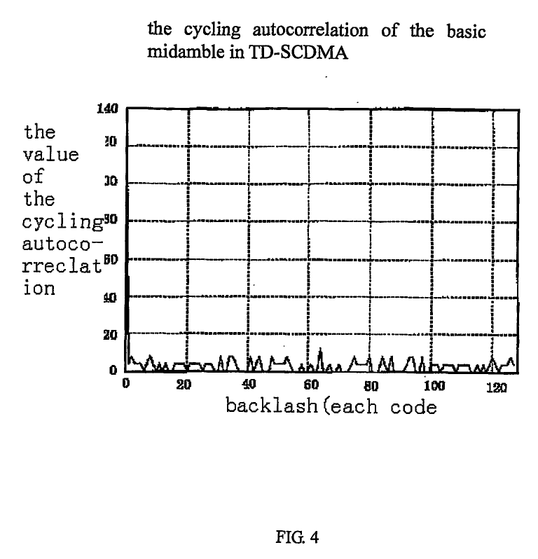

Meanwhile if M is not big enough, the probability of missing detection can be omitted, because in the TDD/CDMA system, the training sequence has a good cycling autocorrelation, and is long enough. For example, in a TD-SCDMA system, the basic training sequence has 128 code chips and has a good cycling autocorrelation, which was shown in FIG. 4. As we see, the peak value [symbol] (0) is 128, yet the biggest side lobe is only 8. The correlation gain is 20*log128, about 42 db. So in conventional examples, there is little possibility for the noise floor to overstep the correlated peak [symbol] (0)*hs₀, so the correlated peak can be detected. If the parameter M is feasible, all the other active training sequences can be detected too, which means the missing detection false can be omitted when SNR is low enough.

So it can be concluded that setting a threshold value for the training sequence, which is equal to M times of the noise power, can assure the performance of the training sequence probe unit. In this embodiment, the threshold value of the training sequence intensity is 2.5 times of the noise power, namely M=2.5.

After obtaining some peak positions and the threshold value of the training sequence intensity, we verify the selected peak value using the noise power to remove possible pseudo peak (Step 505), which can improve the precision of the peak position estimation and the noise power estimation. We verify it on the basic that real peak value is more than 2.5 times of NP to assure hi is big enough, which means that we only care the strongest path position, and omit weaker position. Then revise the noise power estimation using the new peak value (Step 506). If the false peak does not appear, it is not necessary to update the noise power estimation.

The next step is performing the matched filter operation on other possible training sequences at those peak positions obtained in the foregoing steps (Step 507). In this instance, we calculate the output of the matched filter at the 4 peak positions selected above, and get 4 peak values (Step 508).

This step reduces the complexity of the matched filter operation. Since in the downlink of TDD/DS-CDMA, all of the communication pulses are transmitted though the same wireless channel, the peak positions (namely the transmitting path) and the matched filter outputs of every active training sequence are the same. In other words, if the training sequence is active, the output peak of matched filter will also be present at this matched filter output peak of the training sequence. We calculate every other training sequence output peak of the matched filter only at the peak position and choose the maximum. Then we compare it with the threshold value, if the former is bigger, the training sequence is taken present (eg. the corresponding interference is active). This means we performs the matched filter operations to get the maximum and judge whether the user is active only at the peak positions, not all the possible positions. For instance, in FIG. 3, the matched filter operation for other training sequences is performed only at a, b, c, d, so the complexity decreases greatly.

Finally, we compare the maximum of the 4 peaks with the threshold value to judge whether the corresponding training sequence is active (Step 509). If the maximum is bigger, the training sequence is active; otherwise it is inactive.

In this embodiment, the detailed rules for judgment are:

If other_peak/Peak(1)>0.9 and (others_peak/NP)>2.5, the possible training sequences are inactive;

Else if (other_peak/Peak(1)>0.5) and (others_peak/NP)>3.3, the possible training sequences are active;

If the two conditions above are not satisfied, the possible training sequences are inactive.

Where, other_peak is the peak value of the matched filter for the possible training sequence at the peak position, Peak(1) is the peak value for this training sequence. NP is the noise power.

(others_peak/NP)>2.5 and (others_peak/NP)>3.3 can assure adequate SNR of the detected path or peak value. (other_peak/Peak(1)>0.9) and (other_peak/Peak(1)>0.5) can assure the training sequence is big enough so that it can be concluded that the training sequence is active.

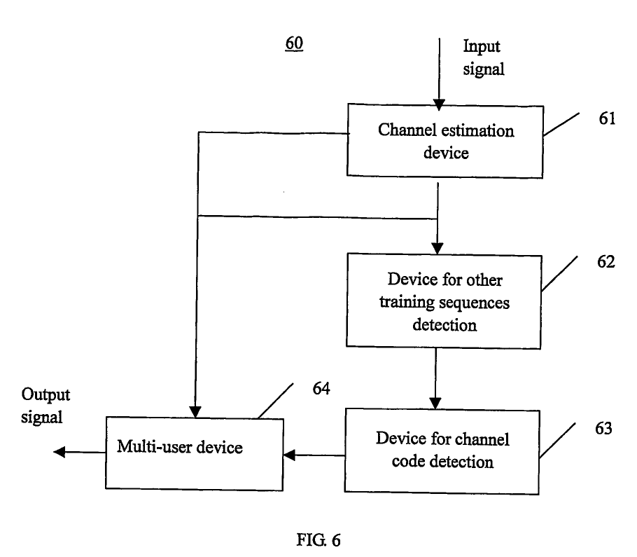

FIG. 6 is the UE receiver 60 according to the training sequence detection method of this invention. This receiver 60 includes channel estimating device 61, other training sequences detection device 62, channel code detection device 63 and multi-user detection device 64.

The device 61 obtains multiple peak positions by performing the matched filter operation on the training sequence at all the possible position.

The device 61 also gets a threshold value of the training sequence intensity, which is a predetermined times of the estimated noise power. The noise power is obtained by averaging the matched filter output power of the training sequence at the other positions excluding the multiple peak positions. The amplitude of the multiple peaks is more than N times of the maximal peak output of the matched filter, where N ranges between 0 and 1 and can be optimized according to a given system. Usually, N is approximately equal to 0.5.

Moreover, the multiple peak values are verified to remove the false by using the noise power. It is done in this way: if the amplitude of the peak value is bigger than the predetermined times of the noise power, it is true; otherwise, it is false.

Said other training sequences detection device 62 checks the intensity of other training sequence at the peak positions, and judges whether they are active by their intensity. The method is: compare the maximal peak value with the threshold value, if the former is bigger, the training sequence is active.

Then, the device 63 will detect the active channel codes based on the detected active training sequence and the corresponding relation between the training sequence and the channel code, and then transmits the active channel codes to the multi-user detection device 64, which restores the communication pulse according to the active channel codes and the estimated channel response pulse.

1. A detection method for the downlink training sequence in a TDD/CDMA system, which is used in mobile terminals, comprising the following steps:
a) performing matched filter operation on the training sequence of mobile terminals and getting a number of peak positions;
b) detecting the training sequence intensity of other mobile terminals according to the positions of the formerly obtained multiple peaks;
c) judging whether the training sequences of other mobile terminals are active according to the detected training sequence intensity.

2. A method of claim 1, wherein in step a), a threshold value for detecting training sequence intensity can be achieved by matched filter operations.

3. A method of claim 2, wherein said threshold value is specified times of the estimated noise power.

4. A method of claim 3, wherein noise power is obtained in this way: calculating the power of the matched filter output peaks in step a) excluding said multiple peak values and then calculating their average.

5. A method of claim 1, wherein in step a), every peak among a number of said peaks has an amplitude N times bigger than the biggest peak value respectively, N is a parameter ranges from 0 to 1.

6. A method of claim 5, wherein N can be optimized according to a given system, usually about 0.5.

7. A method of claim 6, wherein noise power can also be used to verify said peaks in order to remove the pseudo peaks.

8. A method of claim 7, wherein the method used to verify the selected peaks to remove pseudo-peaks with noise power is implemented as follows: if said amplitude of the peak value is bigger than the specified times of noise power, it is true; otherwise it is false.

9. A method of claim 2, wherein the judging method in step c) is as follows: comparing the biggest value achieved in step b) with the threshold value of the training sequence intensity obtained in step a), judging whether said training sequences of other mobile terminals are activated; if the biggest peak value is bigger than the threshold of said training sequence intensity, it is activated.

10. A receiver for use in mobile terminals, comprising:
channel estimating means for match-filtering training sequences from a specified mobile terminal and obtaining a number of peak positions; and
other mobile terminals detecting means for detecting intensities of training sequences from other mobile terminals in the peak positions, and judging whether the training sequences of the other mobile terminals are activated according to the intensities.

11. The receiver of claim 10, further comprises channel code detecting means and multi-user detecting means, wherein:
the channel code detecting means detects activated channel code according to the activated training sequences and corresponding relation between the training sequences and channel codes, and gives the activated channel code to the multi-user detecting means; and
the multi-user detecting means recovers communication pulse according to the activated channel code and estimated channel response pulse.

12. The receiver of claim 10, wherein said channel estimation means also can obtain a threshold value for detecting training sequence intensity by matched filter operations.

13. The receiver of claim 12, wherein said threshold value is specified times of noise power estimation.

14. The receiver of claim 13, wherein said noise power is obtained by calculating the noise power average of peaks produced by the matched filter operation excluding said several peaks.

15. The receiver of claim 10, wherein, every peak among a number of said peaks has an amplitude N times bigger than the biggest peak value respectively, N is a parameter ranges from 0 to 1.

16. The receiver of claim 15, wherein N can be optimized according to a given system, usually about 0.5.

17. The receiver of claim 16, wherein noise power can also be used to verify said peaks in order to remove the pseudo peaks.

18. The receiver of claim 17, wherein the scheme used to verify the selected peaks to remove pseudo-peaks with noise power is implemented as follows: if said amplitude of the peak value is bigger than the specified times of noise power, it is true; otherwise it is false.

19. The receiver of claim 18, wherein the judging method is as follows: comparing the biggest value achieved with the threshold value of the training sequence intensity obtained in order to judge whether other training sequences are activated; if the biggest peak value is bigger than the threshold of training sequence intensity, it is activated.

20. A mobile terminal including a receiver as claimed in claim 10.
